(19) United States
(12) Patent Application Publication
(10) Pub. No.: US 2025/0360461 A1
(43) Pub. Date: Nov. 27, 2025

(54) CARBON CAPTURE APPARATUS AND METHOD

(71) Applicant: Airbuild Inc., Vancouver, WA (US)

(72) Inventors: Richard M. Mariita, Troy, NY (US); James H. Davis, Green Island, NY (US)

(21) Appl. No.: 19/214,809

(22) Filed: May 21, 2025

Related U.S. Application Data
(60) Provisional application No. 63/650,205, filed on May 21, 2024.

(51) Int. Cl. B01D 53/62; A01G 33/00; B01D 53/84; H02S 40/00

(52) U.S. Cl. CPC B01D 53/62; A01G 33/00; B01D 53/84; H02S 40/00; B01D 2257/504; B01D 2258/06; B01D 2259/802

(57) ABSTRACT

A carbon sequestration device configured to remove carbon dioxide from environmental air in an exterior environment has a housing forming a concave region with an open top, and a panel covering the open top. At least a portion of the panel is light-transmitting and also includes at least one solar cell. The panel and concave region together form an interior chamber configured to contain water and algae. The device also has an environmental air inlet formed in the housing for receiving pressurized environmental air from the exterior environment, as well as a temperature sensor in thermal communication with the interior chamber to sense the temperature in the interior chamber. The device also has a thermal regulator in thermal communication with the interior chamber. The thermal regulator is configured to control the temperature in the interior chamber as a function of the temperature sensed by the temperature sensor.

### PRIORITY

This patent application claims priority from provisional U.S. patent application No. 63/650,205, filed May 21, 2024 entitled, “CARBON CAPTURE APPARATUS AND METHOD,” and naming James H. Davis and Richard M. Mariita as inventors, the disclosure of which is incorporated herein, in its entirety, by reference.

### FIELD

Illustrative embodiments of the invention generally relate to carbon capture and, more particularly, various embodiments of the invention relate to multi-functional carbon capture devices and methods.

### BACKGROUND

The accumulation of carbon dioxide (CO₂) in the atmosphere, largely from fossil fuel combustion and industrial activity, is believed to be a primary force behind global climate change. Those in the art have responded with carbon capture technologies, which generally are designed to mitigate this by isolating CO₂ before or after it enters the air. The two principal approaches are point-source carbon capture, which targets emissions at their source—such as in power generation or heavy industry—and direct air capture (DAC), which extracts CO₂ already present in the atmosphere. These methods are helpful to efforts aimed at reducing net carbon emissions, especially in sectors where direct reductions are technologically or economically difficult.

Undesirably, however, existing carbon capture systems have significant drawbacks. Point-source methods typically rely on solvents that are costly, corrosive, and degrade over time, leading to frequent replacement and maintenance. These systems also require substantial retrofitting of existing industrial infrastructure, which can be technically complex and economically prohibitive. Direct air capture (DAC) technologies, while not tied to emission sites, often depend on proprietary materials or processes that are difficult to manufacture at scale, suffer from thermal or chemical instability, or have limited lifespans under real-world operating conditions. These material and engineering limitations reduce system reliability and increase lifecycle costs, making widespread deployment difficult.

### SUMMARY OF VARIOUS EMBODIMENTS

In accordance with one embodiment of the invention, a carbon sequestration device configured to remove carbon dioxide from environmental air in an exterior environment has a housing forming a concave region with an open top, and a panel covering the open top. At least a portion of the panel is light-transmitting and also includes at least one solar cell. The panel and concave region together form an interior chamber configured to contain water and algae. The device also has an environmental air inlet formed in the housing for receiving pressurized environmental air from the exterior environment, as well as a temperature sensor in thermal communication with the interior chamber to sense the temperature in the interior chamber. The device also has a thermal regulator in thermal communication with the interior chamber. The thermal regulator is configured to control the temperature in the interior chamber as a function of the temperature sensed by the temperature sensor.

The device also may have a pump inlet for receiving air from a pressurized source to create turbulence in water in the interior chamber when containing water. The housing may further have a front wall, a back wall, and two side walls extending between the front and back walls. The two side walls form an angle to the horizontal of 2 degrees to 15 degrees. To facilitate operation in different weather situations, the thermal regulator may have a heater, a cooler, or a combination heater and cooler. A bubble stone fluidly connected with the environmental air inlet may provide air from the environment.

Some embodiments of the device may have an optical sensor configured to detect the turbidity of water in the interior chamber, and/or a light concentration coating within the interior chamber. Moreover, the panel may be heterogeneous in that it can have at least one electrically inactive region that is opaque or transparent to light.

In addition to the housing and panel apparatus, the device also may have a settling tank inlet fluidly coupled with an external settling tank configured to manage nutrient density and nitrogen levels. The settling fluid tank inlet preferably is configured to receive fluid from the external settling tank. In a corresponding manner, the device also may have a drying tank outlet fluidly coupled with an external drying tank. The interior chamber may be configured to emit water and algae within the interior chamber toward the drying tank after satisfying prescribed algae concentration conditions.

In accordance with another embodiment, a method of sequestering carbon may receive water in a first stage of a carbon capture system configured to determine a water quality, direct the received water into a settling tank after determining that the water quality meets a prescribed criterion, and monitor nitrogen and nutrient density of water in the settling tank. The method may evaporate water in the settling tank when nutrient density within the water in the settling tank is too low, and pass water from the settling tank to a carbon sequestration device having a housing and solar panel that form an interior chamber for receiving the water from the settling tank. Preferably, the solar panel provides power to at least a portion of the carbon capture system.

After determining that the interior chamber of the carbon sequestration device contains at least a prescribed amount of algae, the method may transfer water from the carbon sequestration device to a drying tank. Then, the method may dry the algae in the drying tank to produce biomass.

In accordance with one embodiment, a carbon capture system that also generates electrical power includes at least one body forming a chamber to receive water and algae. The body includes at least a translucent solar panel cover. The system also includes a settling tank fluidically connected to a liquid source. The tank is also fluidically connected to the chamber. The system also includes a drying tank fluidically connected to the chamber, and at least one fluid pump. The at least one fluid pump is configured to move the water and the algae from the chamber to the drying tank. The system also includes a thermal control device (e.g., thermal regulator) positioned in the chamber, the thermal control unit configured to control the temperature of the water. The solar panel may be partially transparent at predetermined wavelengths.

The system may further include a first control valve positioned on a water line fluidically connecting a water source to the settling tank. The system may further include a second control valve position on a water line fluidically connecting the settling tank and the chamber, and the system may also include a third control valve position on a water line fluidically connecting the chamber and the drying tank.

The system may also further include at least one gas bubbler positioned in the chamber. The at least one air bubbler may be fluidically connected to a gas source.

The thermal control device may be configured to maintain a temperature range in the chamber between about 23 degrees C. to 27 degrees C.

The system may also include a light manager configured to maintain a light intensity (μmol/m²/s) between about 350 to 650 at peak wavelengths of 450-495 nm (Blue) and 620 to 750 nm (Red).

The system may be configured for the water to be maintained at a pH of between about 6-8. The system may be configured to maintain nitrogen and phosphorus concentrations in the water of between about 6-12 mg/L and 1-2.5 mg/L, respectively.

The system may further include a system controller. The system controller may include a control system, and the control system may include a valve control module. The valve control module may be configured to receive logic. The control system may include a solar module, a biopanel module, a UVC reactor; and environmental controls. The control system having logic may be configured to receive signal inputs from one or more sensors and provide instructions to one or more of the valve control module, the solar module, the biopanel module, the UVC reactor, or environmental controls.

The system may further include at least one IoT sensor configured to track factors comprising cell density, chlorophyll fluorescence, dissolved oxygen levels, turbidity, and/or UV transmittance (e.g., UVT). One or more of the sensors may include an IoT sensor.

The system may further include at least one liquid pump to circulate liquid in the chamber, and may further include at least one energy storage device.

In accordance with another embodiment, a biopanel that generates electrical power and sequesters carbon includes a body forming a chamber to receive a liquid and algae, one or more sensors configured to measure properties of the biopanel, a thermal control device configured to control the temperature of the liquid; and a translucent solar panel. The translucent solar panel forms a semi-transparent cover at least in part forming the chamber. The solar panel is in electrical connection with an electrical circuit and is configured to provide electrical power to the one or more sensors, and provide electrical power to the thermal control device to support operation of the biopanel up to 12 months a year. The translucent solar panel generates electrical power from sunlight incident on the translucent solar panel, and allows some of the incident sunlight to be transmitted to the algae in the liquid.

The translucent solar panel may utilize a solar absorbent material that is semitransparent in a visible portion of solar radiation. The semi-transparent solar absorbent material may comprise CdTe. The solar panel may use phosphor to concentrate light from the IR and UV spectrum into the PAR growth region.

In accordance with another embodiment, a method to generate electrical power and generate biomass in a single system includes providing a carbon capture system that also generates electrical power. The system includes at least one body forming a chamber to receive water and algae. The body includes at least a translucent solar panel cover. The system also includes a settling tank fluidically connected to a liquid source, and the tank is also fluidically connected to the chamber. The system also includes a drying tank fluidically connected to the chamber, and at least one fluid pump. The at least one fluid pump is configured to move the water and the algae from the chamber to the drying tank. The system also includes a thermal control device positioned in the chamber. The thermal control unit is configured to control the temperature of the water.

The method further includes adding water and algae to the chamber, and placing the carbon capture system in a location with exposure to the sun. The method further includes controlling the temperature of the water.

The translucent solar panel generates electrical power from sunlight incident on the translucent solar panel and allows some of the incident sunlight to be transmitted to the algae in the liquid.

The translucent solar panel may be in electrical connection with an electrical circuit, and may be configured to provide electrical power to the one or more sensors; and may be configured to provide electrical power to the thermal control device to operation of the biopanel up to 12 months a year,

The method may further include automatically controlling a first control valve positioned on a water line fluidically connecting a water source to the settling tank, a second control valve position on a water line fluidically connecting the settling tank and the chamber, and a third control valve position on a water line fluidically connecting the chamber and the drying tank. The automatically controlling may be controlled by a system controller.

The system may further include one or more of the sensors, and may include at least one of the one or more sensors comprise an IoT sensor.

The system may further include at least one IoT sensor configured to track factors comprising cell density, chlorophyll fluorescence, and/or dissolved oxygen levels. Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically shows a photovoltaic array mounted on a flat roof.

FIG. 1B schematically shows a carbon capture system in accordance with various embodiments.

FIG. 1C schematically shows another carbon capture system in accordance with various embodiments.

FIG. 2 schematically shows another carbon capture system in accordance with various embodiments.

FIG. 3A schematically shows details of a biopanel in accordance with illustrative embodiments.

FIG. 3B schematically shows details of another view of a biopanel in accordance with illustrative embodiments.

FIG. 4 shows a solar radiation spectrum with spectral irradiance versus wavelength.

FIG. 5 shows a cadmium telluride (CdTe) transmission spectrum in accordance with illustrative embodiments.

FIG. 6 shows the box in the x-axis of FIG. 4 in accordance with illustrative embodiments.

FIG. 7 shows light power in the PAR region for light on water without a photonic coating in place and with a photonic coating in accordance with illustrative embodiments.

FIG. 8 schematically illustrates the light path for solar radiation through the solar panel with a phosphor layer applied to the inside surface of the solar panel in accordance with illustrative embodiments.

FIG. 9 schematically illustrates an embodiment of a carbon capture system controller in accordance with illustrative embodiments.

FIG. 10 is a flow diagram that shows a decision-making process in choosing what state the inlet control valve should be in in accordance with illustrative embodiments.

FIG. 11 is a flow diagram that shows a decision-making process in choosing what state the Evaporation Control Valve should be in in accordance with illustrative embodiments.

FIG. 12 is a flow diagram that shows a decision-making process in choosing what state the chamber control valve should be in in accordance with illustrative embodiments.

FIG. 13 is a flow diagram that shows a decision-making process in choosing what state the exit control valve should be in in accordance with illustrative embodiments.

FIG. 14 is a flow diagram that shows a decision-making process in choosing if the heater 24 should be on in accordance with illustrative embodiments.

FIG. 15 is a flow diagram that shows a decision-making process in choosing if a new drying tank should be requested in accordance with illustrative embodiments.

FIG. 16 is a flow diagram that shows a decision-making process in choosing if the heater 24 should be on, or if the cooler should be on in accordance with illustrative embodiments.

FIG. 17 describes a method of generating electrical power and generating biomass in a single system in accordance with illustrative embodiments.

### DESCRIPTION OF ILLUSTRATIVE EMBODIMENTS

In illustrative embodiments, a carbon sequestration device can operate in many climates, year around and be self-powering. To that end, a biopanel is configured to include components that sequester carbon dioxide (e.g., CO₂) from air, generate electrical power, grow biomass, and filter gray water. In illustrative embodiments, the biopanel includes a housing forms a concave region with an open top, which may be covered with a semi-transparent panel including at least one solar cell. The panel and concave region may form an interior chamber configured to contain the water and the algae. Among other locations, the biopanel may be located outside on the ground or on a flat roof.

The biopanel provides an environment that supports the growth of algae by allowing the transmission of filtered sunlight into the water/algae mixture, and by maintaining the temperature of the biopanel in a prescribed temperature range that facilitates growth of the algae biomass with electric heaters located on the chamber. The biopanel includes a temperature sensor in electrical communication with the biopanel module and the thermal control devices.

In illustrative embodiments, one or more biopanels may be built up into a carbon capture system that can be a replacement for conventional rooftop solar photovoltaic systems by providing carbon sequestration in addition to photovoltaic power. The carbon capture system (e.g., carbon capture apparatus) can receive gray water (e.g., rain gutter and/or ground water runoff, and the like) that can be pumped into the biopanel that already contains some algae and water.

The received gray water is stored in an equalizer and settling storage tank. The water is pumped through a control valve into the biopanel. After the algae biomass has grown to a predetermined amount, it is pumped out of the biopanel into a drying tank, where it is dried in preparation for shipment.

The carbon capture apparatus (e.g., sequestration system) is configured to work in all four seasons—in normal heat and cold extremes. Moreover, the system should avoid significant inspection requirements because it can be self-powering. Accordingly, various embodiments avoid building electrical connections. In that case, the primary required maintenance will be sensor maintenance, replacing solar panels every 20 years, and removing dried algae from drying tanks for use elsewhere.

In illustrative embodiments, the carbon capture system includes a control system that includes a microcontroller that is configured to receive inputs from various sensors and instruments, and provide outputs that control the operation of various valves, thermal controllers, pumps, and the like. Once the operating conditions are optimized for a given carbon capture system, the system may be operated by the microcontroller based on the received sensor data.

Details are discussed below.

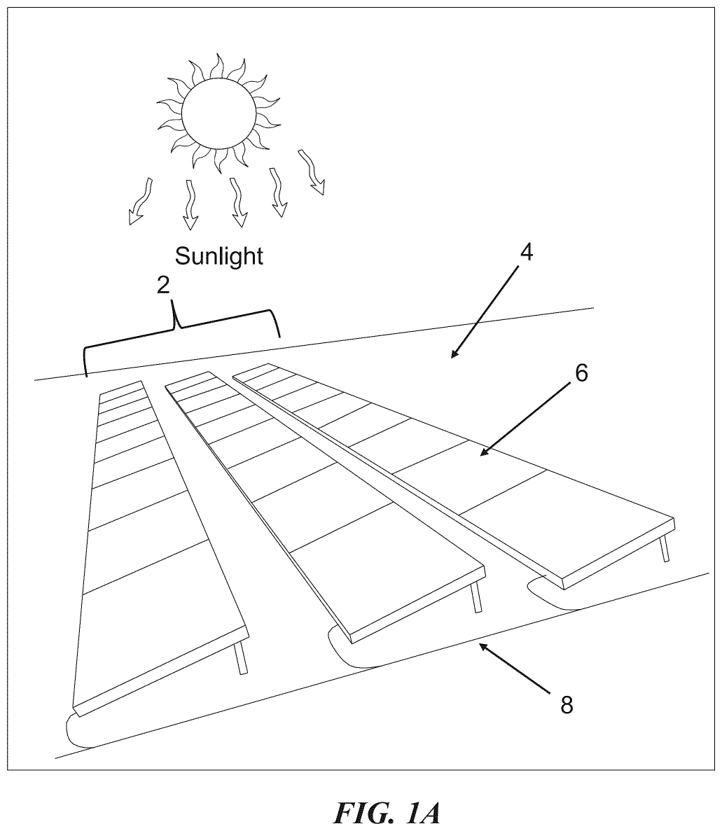

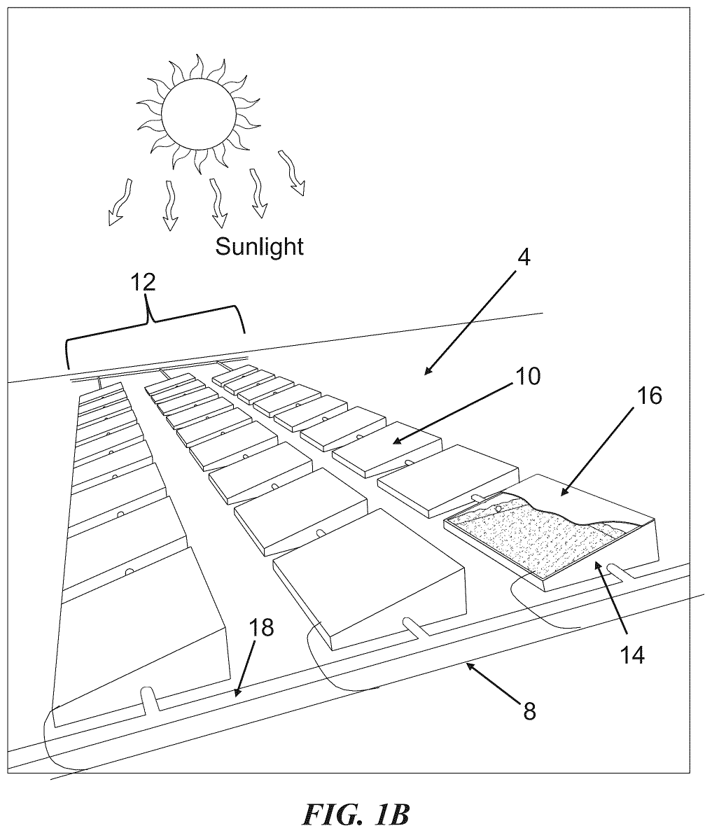

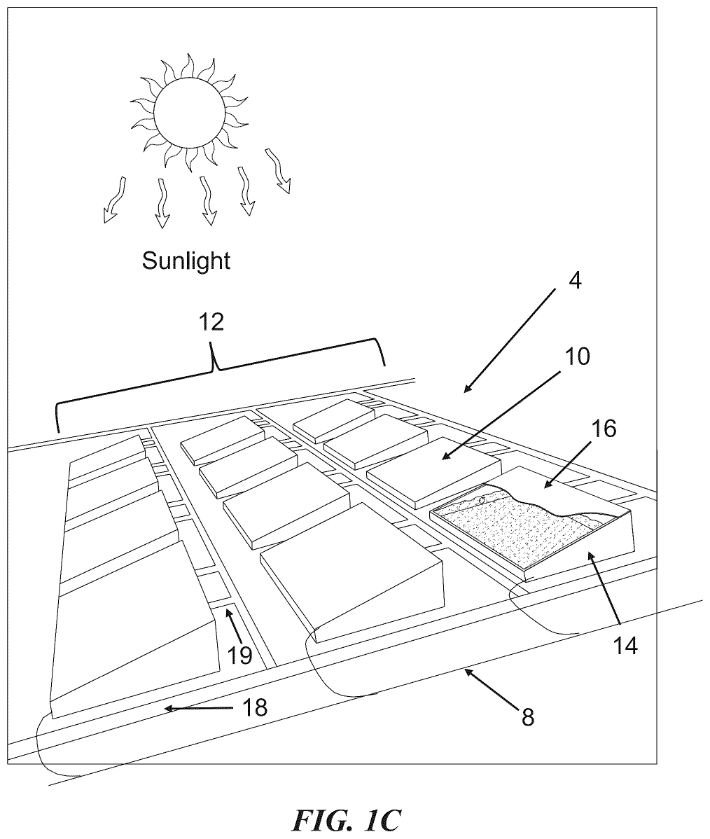

FIG. 1A schematically shows a photovoltaic array 2 (aka “PV” array) mounted on a flat surface (e.g., a flat roof 4). Sunlight is captured by the PV solar panels 6 and transformed into electrical power, which is conducted away from the array by electrical cables 8. Rooftop solar arrays 2 mounted on a flat roof 4 typically have a mounting angle ranging from 10 to 30 degrees. This angle is chosen to maximize sun exposure while minimizing wind resistance and the need for frequent cleaning. A 15-degree angle is often cited as a good compromise, offering sufficient tilt for rain runoff and debris removal without creating too much wind resistance.

FIG. 1B schematically shows an embodiment of a carbon capture system 12 incorporating biopanels 10 in an arrangement similar to the rooftop solar PV array 2. The electrical power is conducted from the array 12 by electrical cables 8. However, in addition to generating electricity, the carbon capture system 12 also sequesters CO₂ by growing a harvest of algae, as well as filtering water runoff.

Each biopanel 10 has a chamber 14 that is configured to contain algae and water, and is covered with a semi-transparent cover 16. In illustrative embodiments, the semi-transparent cover 16 may include the solar cells that may be largely transparent to visible light. The solar cells may be made from materials such as cadmium telluride (e.g., CdTe). In other embodiments, the solar cells may be made from materials that absorb visible light, and thin enough to be partially transparent. The cover 16 may have at least one electrically inactive region that is opaque or transparent to light. Moreover, the solar cells may be opaque to light. In such latter case, the cover 16 also has portion(s) transparent or at least transmissive to light of a sufficient amount for algae growth. In these noted embodiments, the cover 16 should permit light sufficient for algae growth.

In other illustrative embodiments, the cover 16 is a semi-transparent (e.g., translucent) rigid material such as a polymeric or glass material. In these embodiments, the biopanels do not generate electrical power, but they do allow filtered sunlight to pass through to support growth of the algae.

A phosphor material also may be added to an inside surface of the semi-transparent covers to increase the amount of filtered light in a beneficial region of the spectrum for algae growth.

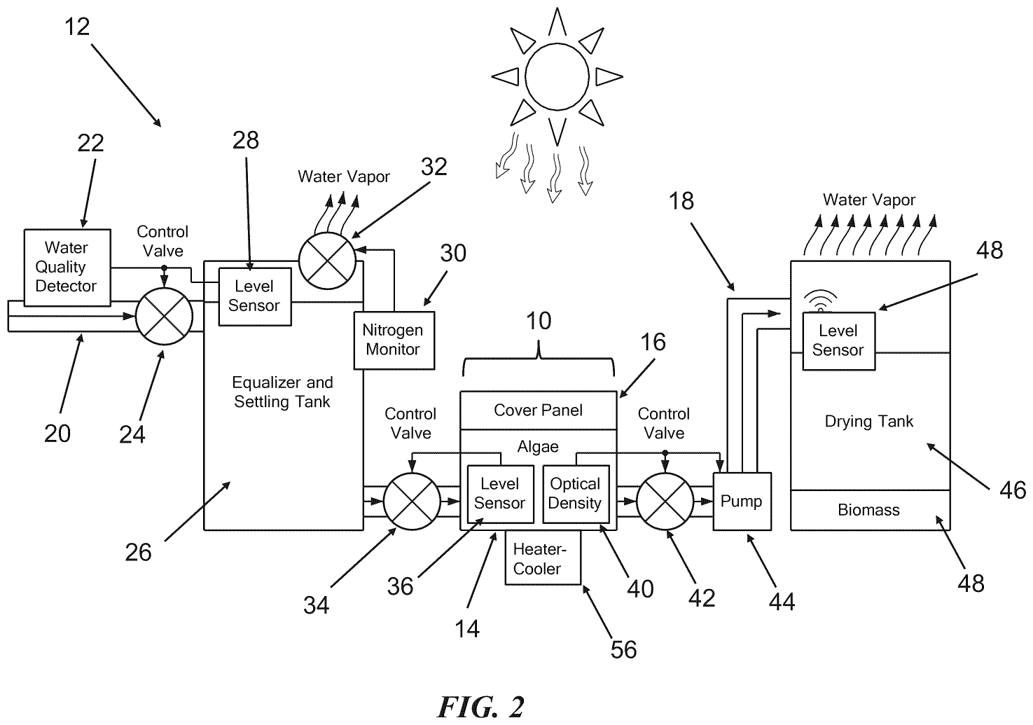

Water flows in and out of the chambers 14 in the carbon capture system 12 via one or more pipes 18. The water flows from settling tanks through the biopanels 10, and then into drying tanks (described in more detail in FIG. 2). The introduction of the water into the chambers 14 is controlled by valves positioned on the piping 18 at the entry and exit of each chamber 14. These allow a precise amount of water to be pumped into the chambers 14 based on sensors in the chambers. Among other things, sensors in the chamber 14 measures the content of algae present. Accordingly, when the volume of algae in the chambers 14 has reached a predetermined amount, the algae is removed and pumped into drying tanks by flowing water out of the chambers 14.

FIG. 1C schematically shows another embodiment of the carbon capture system 12 (e.g., apparatus) mounted on a flat surface 4 incorporating biopanels in an arrangement similar to the rooftop solar PV array 2 in FIG. 1A. However, in the embodiment shown in FIG. 1C, the piping 18 does not run through each biopanel 10. Instead, the piping 18 of this embodiment runs outside of the biopanels 10 and has two branches 19 connected to each chamber 14. This piping arrangement enables separate filling and emptying of the chambers 14. The introduction of the water into the chambers 14 through the branches 19 preferably is controlled by smart valves positioned on the branches 19 at the entry at the top the chambers 14. Similarly, the branches 19 proceeding into and out of each chamber 14 allow a precise amount of water to be pumped from each chamber 14 based on sensors in the chambers.

FIG. 2 schematically shows more details of the carbon capture system 12 in accordance with various embodiments. In this example, runoff water (or water from another source) enters on the left from a water line 20 and is tested by a water quality detector/chemical sensor 22 to determine if the water quality is sufficient to be permitted into the system 12. This may be considered a first stage of the carbon capture system. Runoff water may come from roof tops, and/or be pumped to the system from well water, ponds at golf course, river water, and the like. Potential contaminants that can be present in water runoff includes ammonia, bleaches, and chlorine, or other cleaning agents. In some embodiments, Raman spectroscopy may be incorporated as a chemical sensor (e.g., detector).

If the water in the water line 20 (e.g., settling tank inlet) is determined by the chemical sensor 22 to be sufficiently free of contaminants, the water can be permitted to flow past the inlet control valve 24 and into an equalizing and settling tank 26. The inlet control valve 24 can be automatically controlled by a valve control module controller system based on the reading from the chemical sensor 22. An ultraviolet C (e.g., UVC) reactor 66 may be incorporated into the water quality detector 22 to measure nitrate levels in the water line 20. The UVC reactor may provide a flow sensor 68 and a microdosing mechanism 69.

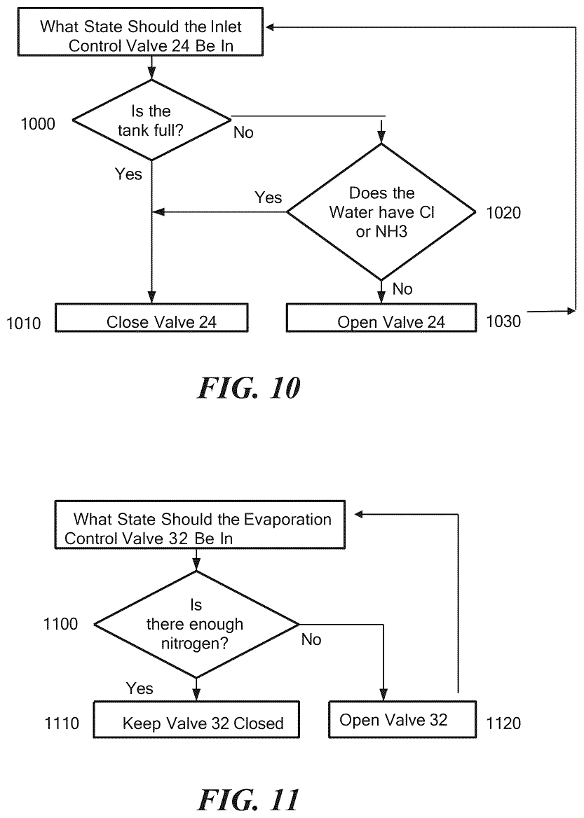

After the water is allowed into the equalizer tank (e.g., external settling tank), entrained solids in the water can settle out of the solution. The water levels are measured by a tank water level sensor 28, which can also provide inputs into the valve control module controller 60 of the system controller 58. The valve control module 60 includes the automated controls for each of the valves in the system 12. Examples of the automated decision processes made with the valve controllers in the valve control module 60 are discussed below with FIGS. 10-16.

A nitrogen level monitor 30 in or on the equalizing and settling tank 26 can detect the nitrogen nutrient density in the tank 26. The nitrogen level monitor 30 is in signal communication with an evaporation control valve controller 32 in the valve control module 60. If the nitrogen concentration is too low, the valve control module 60 opens the evaporation control valve 32 on the equalizer tank 26 to allow water to evaporate out of the tank 26—thus increasing the ‘strength’ of the sewage.

Water from the equalizer and settling tank 26 flows through a chamber control valve 34 into the chamber 14 of the biopanel 10. The chamber control valve 34 may be automatically controlled by a chamber control valve controller 34 in the valve control module 60. Water fills the chamber 14 to a predetermined level, which is monitored by a chamber water level sensor 36.

In illustrative embodiments, the biopanel cover 16 may be a semi-transparent solar panel. The transparency of the cover 16 may be controlled by the selection of the solar absorber material. In some embodiments, the solar panel includes cadmium telluride (e.g., CdTe) to convert infrared (e.g., IR) wavelength solar radiation into electrical power. Solar panels made from IR absorbing materials can be designed to allow higher energy (e.g., shorter wavelength) radiation pass through the solar panel to support the algae and water in the chamber. The electrical power is carried out of the solar panel be electrical wiring 8 (e.g., power lines).

Alternatively, the biopanel cover 16 may be a semi-transparent plastic (e.g., polymeric) sheet or glass sheet. The transparency of the plastic or glass cover 16 may be controlled by the selection of the sheet material. The transparency may also by tailored by the addition of phosphors and/or photonic crystal layers on the inside surface of the biopanel cover 16 (i.e., the surface of the cover 16 that faces the water and algae).

The water level in the chamber 14 is monitored by a chamber water level sensor 36, which is in electrical communication with the chamber control valve 34. In some embodiments, the water level sensor is an ultrasonic water level transducer. In use, the water level sensor 36 detects when the water level in the chamber 14 is below a predetermined level, and signals the valve control module to admit more water by opening the chamber control valve 34, causing water to flow from the equalizer tank 26.

The power generated from the solar panel may be used to power some or all the electronics, as well as charge a battery, or some other energy storage device. Also, as noted above, the panel 16 enables enough light to pass through to promote and support the algae growth processes within the chamber 14.

To ensure algal growth across all seasons, a temperature control device 56 can be used for one or both heating and cooling (e.g., a Peltier plate, a thermoelectric cooler that can be used for both heating and cooling). In this example, the Peltier plate may reverse the current flow, and act as a heat pump in winter and a chiller in hot summers.

The system 12 removes much of the algae biomass from the biopanel 10 when the total volume of biomass reaches a predetermined amount. That is, the algae are removed after it reaches a prescribed concentration within the biopanel 10. Those skilled in the art may select an appropriate method of determining the timing and predetermined amount. For example, the amount may be determined by optical density measurements. In that case, the algae are allowed to grow until an optical density measurement detects saturating growth. In illustrative embodiments, an optical density measurement system 40 used for these purposes may include a photodetector (e.g., optical sensor) and an LED (e.g., light emitting diode). The optical density measurement system 40 may be configured to have the photodetector (e.g., light sensor) measure LED light reflected from an inside surface of the chamber 14 to measure how much the algae has grown, and the algae growth rate. The optical system 40 may be signally connected to the system controller such that the output signal generated from the optical system 40 may be used by the valve control module to open (automatically) the exit control valve 42, and then turn on pump 44 to flush out water and algae from the biopanel 10 and pump them into a drying tank 46 (e.g., external drying tank). It may take between 5 to 70 days for the growth rate of the algae to decrease to the predetermined level to trigger removal of the algae.

High controllability of environmental factors, such as light intensity, temperature, nutrient levels, etc., permits more precise optimization of growth conditions, resulting in more carbon sequestration, and higher biomass production. The duration it takes for growth saturation depends on the strain used, light intensity, nutrient concentrations, temperature, and pH, among other things.

At or after that time that the optical density measurements have indicated that the algae should be removed, the exit control valve 42 opens, and the system turns on the pump 44. The water and algae are pumped through a drying tank outlet to the external drying tank 46. Water slowly evaporates from the tank, and the biomass 48 settles to the bottom. As with other components of the system 12, the drying tank 46 has a drying tank water level sensor 48 to measure water level. After the water level reaches a predetermined level, the system sends a message to an operator or an automated system to request a replacement drying tank 46. The drying tank 46 then may be removed along with the biomass, and a new drying tank 46 may be positioned in place. Accordingly, the harvested algae may be used as raw biomass material for numerous products.

Water agitation, which circulates water around the algae tank, enhances algae growth to stop or slow algae from settling at the bottom. To that end, in preferred embodiments, an air stone 50 (e.g., bubble stone) or other bubbler in the chamber 14 agitates the water and introduces CO₂ to the algae. An air pump may bubble air through the air stone 50. Moreover, to run at night or on a cloudy day, many systems also have a power source, such as a battery or an electrical connection to a grid source of electrical power. Indeed, the battery preferably is charged during the day or other times from light absorbed by the solar cells/panel.

Those skilled in the art may select an appropriate algal species or consortium of algae. After experimentation and discovery, the inventors recognized that several algal species optimized and utilized for the biopanel include Green algae (Scenedesmus obliquus, Scenedesmus acuminatus, Scenedesmus quadricauda, Scenedesmus dimorphus, Scenedesmus acutus, Scenedesmus bijuga, Chlorella kessleri, Chlorella vulgaris, Chlorella sorokiniana, Chlorella minutissima, Chlorella pyrenoidosa, Dunaliella salina) and Diatoms (Thalassiosira pseudonana, Phaeodactylum tricornutum). These algal species are used as monoculture, or polyculture under standardized conditions.

These algal strains were determined to require light intensity (μmol/m²/s) in the ranges of 350 to 650 at peak wavelengths of 450-495 nm (Blue) and 620 to 750 nm (Red). Growth for maximum carbon sequestration and biomass is optimized at 23-27° C. at a pH of 6-8. Nitrogen and phosphorus concentrations in the growth medium are 6-12 and 1-2.5 mg/L, respectively. Growth rates for algal species are controlled for applications based on how fast or slow the target application wants algae to grow. Such selection depends on the algae species or mixtures/consortia's growth rate, environmental and CO₂ tolerance, and adaptability to expected environmental conditions within the built environment. These conditions include light intensity and light management, which could involve transparent materials, light diffusers, or even integrated LED lighting systems embedded into biopanels, tailored to the chosen algae's light requirements, temperature, nutrient availability, adjustments in gas exchange components, nutrient delivery (slow or fast release of nutrients from the reservoir). Nutrients will be supplied in solid, liquid, or gaseous form.

The microcontroller 59, which may be implemented with a programmable unit, collects data from the various sensors in the system 12 and controls the heating or cooling of the biopanels 10 in the system based on desirable temperature ranges provided. The microcontroller 59 also incorporates the various sensor readings to automatically control the valves in the system 12. This helps to maintain a consistent environment for optimal algal growth year-round, while ensuring energy efficiency and real time monitoring from many locations.

Negligible to no carbon is provided in growth media, enabling the algal species to take up the carbon dioxide bubbled in through the air stone.

In illustrative embodiments, carbon capture systems 12 may have many more biopanels 10 than equalizing tanks 26 or drying tanks 46. For example, an array of biopanels 10 may have 10 biopanels per drying tank 46, or 100 biopanels per drying tank 46, or 1000 biopanels per drying tank 46.

Similarly, in illustrative embodiments, carbon capture systems 12 may have many more biopanels 10 than equalizing tanks 26. For example, an array of biopanels 10 may have 10 biopanels per equalizing tank 26, or 100 biopanels per equalizing tank 26, or 1000 biopanels per equalizing tank 26.

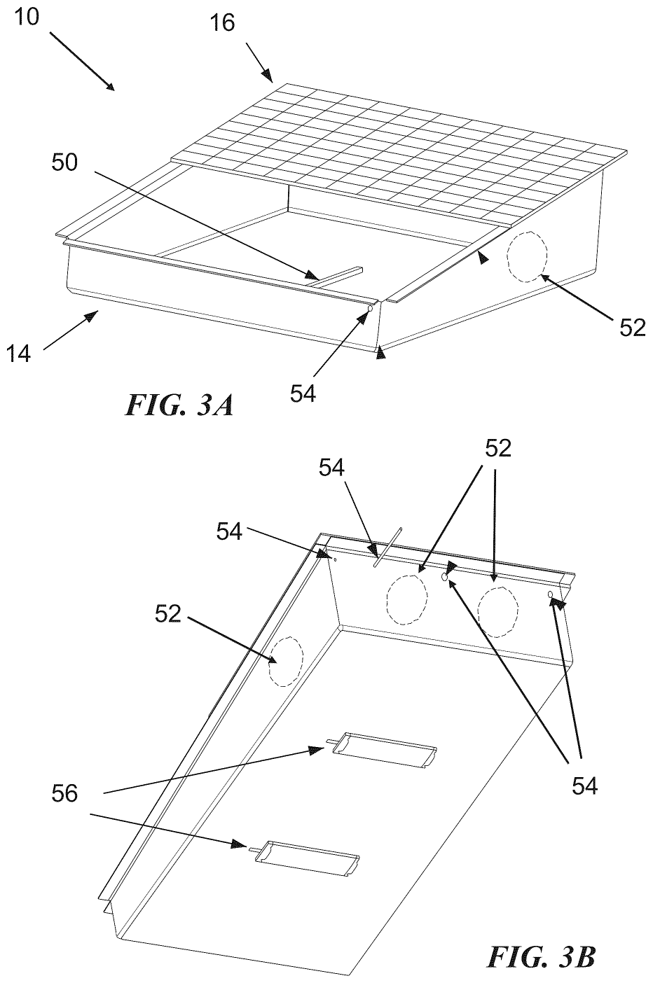

FIG. 3A schematically shows more details of the biopanel 10 in accordance with illustrative embodiments. The biopanel 10 is shown partially covered in the top view by either a solar panel or a polycarbonate top (for experimentation). The lower portion of the cover 16 is removed to show the inside of the biopanel 10. The cover 16 is at a prescribed tilt angle relative to the bottom of the chamber 14 so that, as water evaporates, it condenses on the top, then rolls down and collects on one side, and then falls back into the chamber 14. Preferably, the tilt angle positions the solar panel at an optimum angle relative to the sun for a system mounted on a flat surface, similar to the solar array 2 shown in FIG. 1A. That tilt angle may be between 2-25 degrees, such as about 15 degrees.

The above noted air stone 50 is placed within the chamber 14 (e.g., near the center of the chamber 14) and connected to an air inlet. The size and number of air stones 50 incorporated in each biopanel 10 may be adjusted to accommodate the size of biopanel 10 deployed, as well as the local environmental conditions. Air pumps may be incorporated with the air stones to provide turbulence to the water and algae.

Water enters and exits the biopanel 10 through openings 52 in the side walls and/or back walls of the chamber 14. Depending on the arrangement of the biopanels 10 in the carbon capture system array 12, the openings 52 in the chamber 14 may be through the sides the backs of the biopanels. The openings 52 are indicated in dashed lines to indicate potential locations of the openings in a non-limiting illustration.

In illustrative embodiments, the chamber 14 is formed from a housing of low-cost, thermally insulating polymeric sheets that have been heated and bent into shape. In illustrative embodiments, the polymer may be polyvinyl chloride (PVC), poly carbonate, and the like. Ports 54 may be located on the housing/chamber 14 to permit cabling, sensors, and monitors to be introduced to the biopanel. Thermal control devices 56, such as the above noted Peltier devices, may be located the bottom of the biopanel 10 to permit thermal measurement and heating or cooling based on environmental conditions. Various embodiments also have insulation (not shown) around the outside of the chamber 14 of the biopanel to keep it warm during the winter.

A small space (e.g., 2-3 inches) maintained between the surface of the water and the bottom of the cover 16 prevents algal biofilm formation on the bottom of the cover 16. Further, in some embodiments, a stirrer in the chamber 14 mixes the algae and water in the biopanel 10, which helps prevent biofilms from forming on the surface of the water that can reduce light penetration, and aids in homogenous distribution of nutrients and gasses in the system.

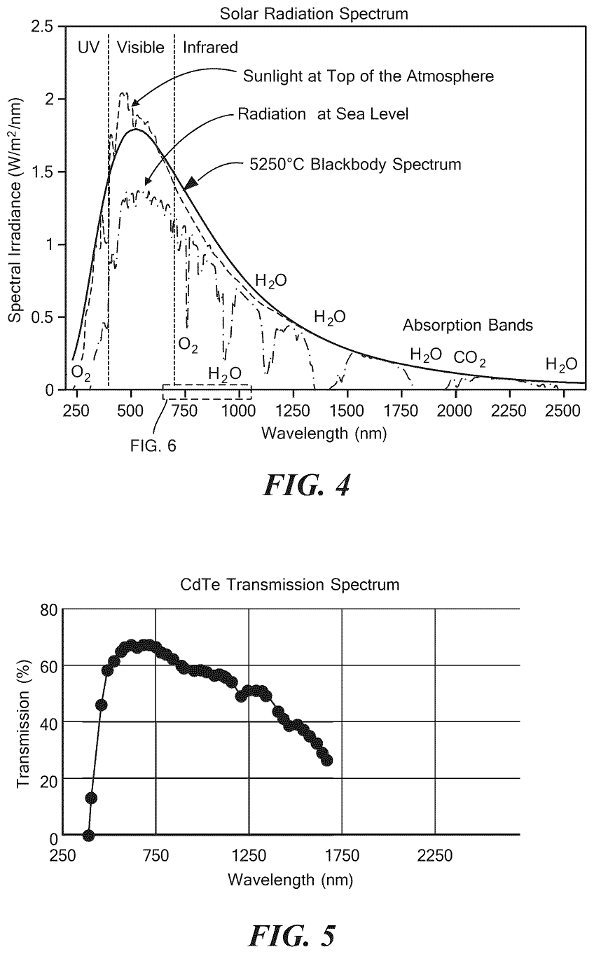

FIG. 4 shows a solar radiation spectrum with spectral irradiance versus wavelength. The highest dashed line shows what the solar spectrum is at the top of Earth's atmosphere. The lower dashed line shows a solar spectrum at sea level. The solar spectrum at sea level has absorption bands associated with oxygen (O₂) and water (H₂O) that reduce the amount of solar radiation at those wavelength bands. The solid line illustrates a blackbody radiation spectrum at a temperature of 5,250 degrees C. The UV (e.g., ultraviolet), Visible, and Infrared (e.g., IR) regions of the spectra are indicated by the vertical lines.

In illustrative embodiments, some of sunlight incident upon the solar panel covers 16 of the carbon capture system 12 is converted to electrical energy by the translucent solar panels. Furthermore, some of the solar radiation is transmitted through the translucent solar panels into the water and algae in the chamber 14 and is used by the algae to convert atmospheric CO₂ into more algae biomass. Thus, the system generates electrical power and sequesters carbon dioxide from the air by growing biomass.

As the sunlight hits the solar panels, it has a broad spectrum ranging from around 300 to 2500 nm. This light is incident onto the solar panel, which produces electricity to charge one or more batteries and power the system. This incident light also can provide extra power back to facility owners for use or eliminate electrical inspection and upgrade requirements to reduce cost by making the system independent.

It has been shown that light in the ranges of about 450-495 nm (Blue) and about 620 to 750 nm (Red) are important to the growth of algae. However, the light transmitted on and/or through the solar panel still has an extensive spectral range from about 400 to about 2000 nm. Most of this light does is not effective at growing algae, as the photosynthetic active radiation (PAR) spectrum is from about 450 to 750 nm with peak activity around 450 and 650 nm.

FIG. 5 shows a cadmium telluride (CdTe) transmission spectrum. The transmission spectrum indicates that the translucent CdTe solar panels will have a band of greatest transmission between about 500 nm and about 900 nm with transmission decreasing monotonically through 1750 nm. Thus, the peak transmission band overlaps with the PAR spectrum. However, even though the peak transmission CdTe band overlaps the PAR spectrum, the CdTe material still absorbs at least 30% of the light incident on the solar panel in the PAR region.

Thus, shading from the solar panel reduces the amount of PAR and non-PAR light. Illustrative embodiments obviate this problem by concentrating light from other portions of the solar spectrum.

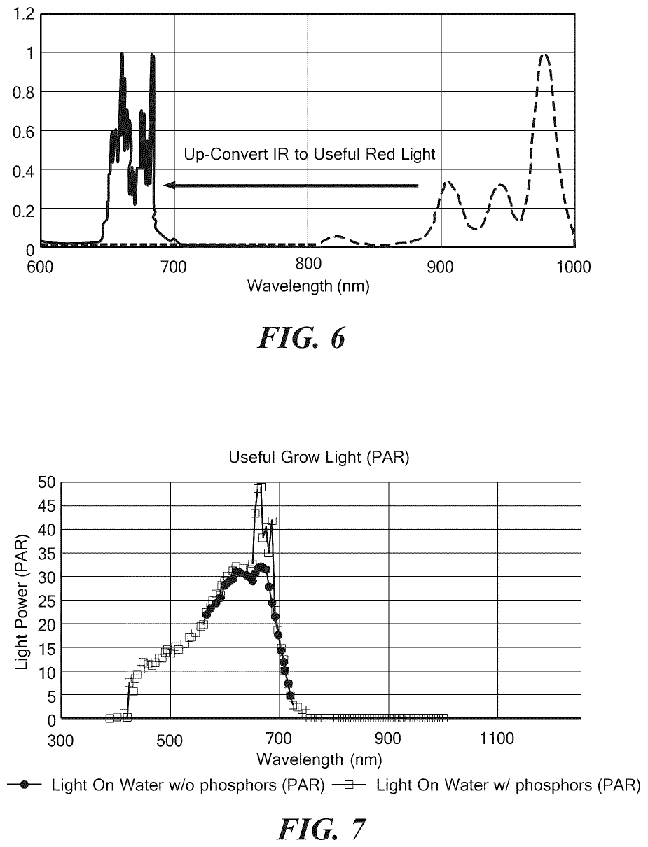

FIG. 6 shows the box in the x-axis of FIG. 4, highlighting a wavelength region of from about 600 nm to about 1000 nm. The dashed line spectrum between 800 nm and 1000 nm is in the IR region of the transmission spectrum. In illustrative embodiments, phosphors, photonic crystals, and/or dichroic filters and mirrors may be incorporated onto the inside surface (e.g., the surface facing the water and algae) of the biopanels 10 by dispersing them in an epoxy film. Examples of anti-stokes phosphors include rare-earth ion doped host materials. Rare-earth ions such as Er= and Tm= may be dispersed into a host material such as NaYF₄, Y₂O₃, Al₂O₃, TiO₂. Concentration of the PAR light can be done with an anti-stokes phosphor as a luminescent solar concentrator (LSC) for increased light absorption, which upshifts light from the IR spectrum to the red spectrum. This results in a small but valuable boost in the PAR growing light, allowing a more absorbing and efficient solar panel.

Examples of photonic crystals include materials made from titanium dioxide (TiO₂) or aluminum oxide (Al₂O₃), which may be incorporated on the inside surface of the solar panels. The photonic crystals reflect and focus the blue and the red light efficiently. In certain embodiments, one-dimensional Al₂O₃/TiO₂ composite crystal may be incorporated to intensify targeted PAR wavelengths. Furthermore, nanostructured materials with periodic dielectric properties that create photonic band gaps may be incorporated on the solar panels. These materials selectively interact with specific wavelengths like blue (400-500 nm) or red (620-750 nm) for high precision wavelength control without luminescence, avoiding energy loss from phosphor decay. Dichroic filters and mirrors in the form of thin-film coatings on glass or polymers that reflect specific wavelengths while transmitting others, may be incorporated to concentrate blue and red light. In illustrative embodiments, the dichroic filters and mirrors are incorporated similarly to how they are used in systems like solar concentrators or photochemical reactors. In some embodiments, the biopanel includes a light concentrating coating within the interior chamber.

Referring again to FIG. 6, in illustrative embodiments, the phosphors or photonic crystals may be incorporated to upconvert IR radiation to redlight in the PAR region. The addition of Al₂O₃/TiO₂ composite crystals embedded in an epoxy film can provide anti-Stokes upconverting of the transmitted IR radiation. Photonic crystals provide precise wavelength control, focusing only the photosynthetically active radiation (PAR) needed for algae (450-750 nm). The periodic dielectric structures create photonic band gaps, ensuring high precision in wavelength control without luminescence, avoiding energy losses from phosphor decay.

FIG. 7 shows light power in the PAR region for light on water without a photonic coating (solid black squares) in place and with a photonic coating (empty squares). Without the photonic coating, the transmitted radiation had a light power of about 32 in the PAR region. However, with the photonic coating, the light power nearly reached 50 in a narrow portion of the PAR region. Thus, the photonic coatings are beneficial for increasing the transmitted light strength ion the PAR region.

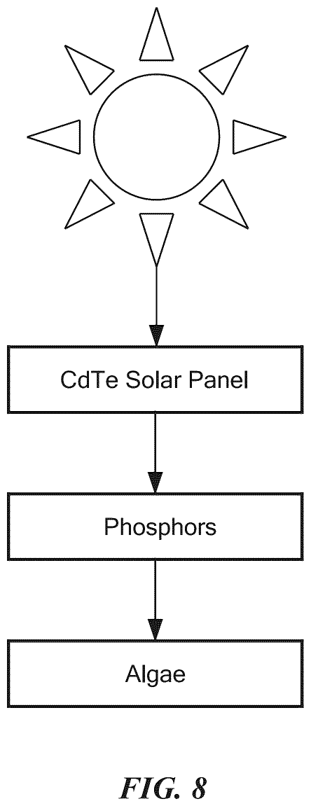

FIG. 8 schematically illustrates the light path for solar radiation through the solar panel with a phosphor layer applied to the inside surface of the solar panel. The sunlight passes into the CdTe solar cell material, and a portion of the solar radiation is absorbed by the solar material and is converted into electrical power. Some of the incident solar radiation is transmitted through the CdTe solar materials and interacts with the photonic crystals in the matrix attached to the inside surface of the solar panel. Some of that transmitted radiation is upconverted from IR wavelengths to the PAR wavelength region.

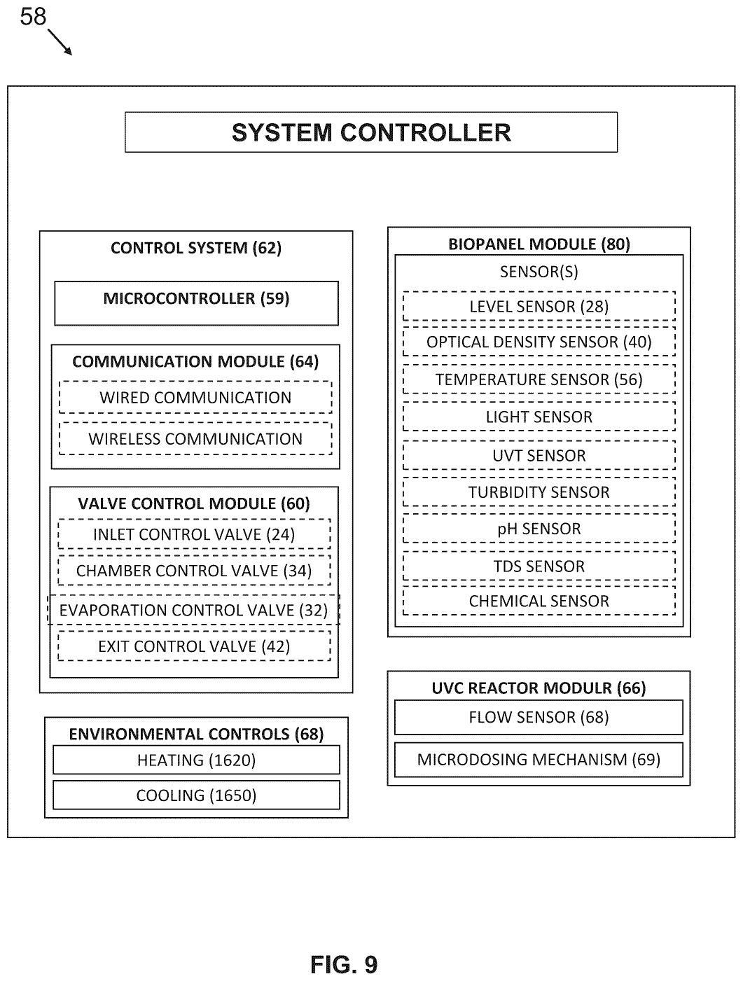

FIG. 9 schematically illustrates an embodiment of the carbon capture system controller 58. As shown, the system controller 58 includes a control system 62, which includes a communication module 64 that provides wired and wireless communication between the system and one or more users. The control system also includes a valve control module 60 that receives input from sensors, and can provide individual control of each valve to facilitate automatically moving water and algae through the system 12. The system controller 58 also includes a UVC reactor module 66 controller. The system controller 58 also provides an environmental controller 68 that receives thermal sensor data and can control thermal control devices 56 to maintain the water temperature in the chambers 14 at optimal temperatures.

The system controller 58 also provides biopanel controller module 70 that receives data from sensors positioned in and around the biopanel 10. These sensors include level sensors 28, optical density sensors 40, temperature sensors on the thermal control devices 56, and light sensors and photodetectors. The biopanels may also include a UVT sensor to measure UV transmittance through the water, a turbidity sensor to measure the turbidity of the water, a pH sensor to measure a pH of the water, and a TDS sensor to measure total dissolved solids in the water. Each of these sensors may be in electrical connection with the microcontroller 59 in the control system 62. The signals from each sensor may be used to automatically control the various valves and pumps that move the water and algae through the system 12 from the water inlet 20 to the drying tank 46. Examples of system controls that provide nearly independent control loops are provided below in FIGS. 10-16.

In illustrative embodiments, the carbon capture system controller 58 operates with several nearly independent control loops. Specifically, in addition to the actions described above, these loops can also monitor algal growth using sensors, such as Internet of Things (IoT) sensors. To better understand when each action is taken, below as FIGS. 10-16 are flow diagrams that show a decision-making process in illustrative embodiments. It should be noted that these processes are an example and not necessarily intended to limit some embodiments. For example, some steps may be completed in a different order or at the same time, and/or some steps may be omitted. As such, those skilled in the art may modify the process as appropriate.

The noted IoT sensors can track factors such as cell density, chlorophyll fluorescence, dissolved oxygen levels, turbidity, as well as UV transmittance (e.g., UVT). By monitoring these factors, the system can gain insights into the health and productivity of the algae culture, enabling optimized control of the system and improved algal growth. The inventors recognized that the integration of IoT sensors and automated decision-making provides a more efficient and intelligent approach to algal cultivation in the biopanels. Among other things, IoT in this context provides insights for optimizing the system and improving algal growth. Importantly, use of these sensors underscores the automated decision-making based on sensor data, highlighting an intelligent approach and desirable result. Automation is also helpful for the reduction in the cost of ownership.

The carbon capture system controller 58 also may use ultrasonic-level sensors to avoid biofouling. UVC nitrate sensors 66, for example, may measure nitrate concentrations while avoiding biofouling. The optical density measurement is a standoff-based system where a red laser bounces off the panel bottom and back into a photodetector. The amount of light returned to the detector—the light before and after the light is on, indicates the optical density. The heaters are implemented, in this embodiment, as a pair of simple thermal elements connected to a thermocouple. The primary controller may be a basic Raspberry Pi with a WIFI module, so the software can be maintained and upgraded to prevent cyber-attacks.

FIG. 10 is a flow diagram that shows a decision-making process in choosing the state of the inlet control valve 24. At the first step 1000, the tank level sensor 28 is interrogated to determine if the equalizer and settling tank 26 is full. If the tank 26 is full, then the inlet control valve 24 should be in the closed state 1010. If the tank 26 is not full, then the chemical sensor 22 is interrogated 1020 to determine if the water in the water line 20 is sufficiently free of chlorine (e.g., Cl₂) or ammonia (e.g., NH₃). If the answer to that is yes, then the inlet control valve 24 should be in the open state until the tank 26 is full. Conversely, if the answer is no, then the control valve 24 is opened. After opening valve 24, the process returns to step 1000.

FIG. 11 is a flow diagram that shows a decision-making process in choosing the state of the Evaporation Control Valve 32. At the first step 1100, the nitrogen level monitor 30 is interrogated to determine if the nitrogen level has sufficient nutrient density. If nutrient density is high enough, then the inlet Evaporation Control Valve 32 should be in the closed state 1110. If the nutrient density is not high enough, then the Evaporation Control Valve 32 should be in the open state 1120. After opening valve 32, the process returns to step 1100.

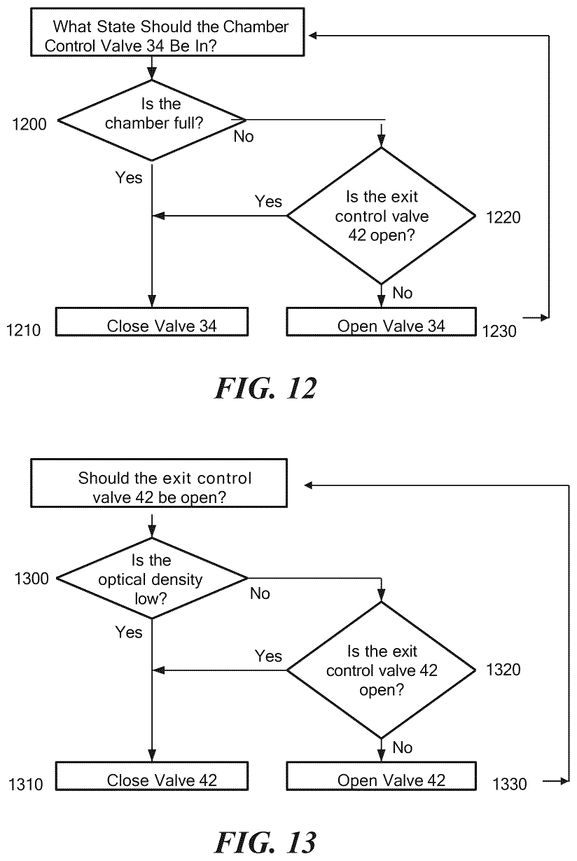

FIG. 12 is a flow diagram that shows a decision-making process in choosing the state of the chamber control valve 34. At the first step 1200, the chamber 14 water level sensor 36 is interrogated to determine if the biopanel chamber 14 is full. If the chamber 14 is full, then the chamber control valve 34 should be in the closed state 1210. If the chamber 14 is not full, then the exit control valve 42 is interrogated 1220 to determine if the exit control valve 42 is open. If the exit control valve 42 is open, then the chamber control valve 34 should be in the closed state 1210. If the exit control valve 42 is closed, then chamber control valve 34 should be in the open state 1230 until the chamber 14 is full. After opening chamber control valve 34, the process returns to step 1200.

FIG. 13 is a flow diagram that shows a decision-making process in choosing the state of the exit control valve 42. At the first step 1300, the optical system 40 is interrogated to determine if the optical density is low. If the optical density is low, then the exit control valve 42 should be in the closed state 1310. If the optical density is not low, then the exit control valve 42 is interrogated to determine if the exit control valve 42 is open. If the exit control valve 42 is open, then the exit control valve 24 should be in the closed state. If the exit control valve 42 is closed, then exit control valve 42 should be in the open state until the optical density is low 1330. After opening exit control valve 42, the process returns to step 1300.

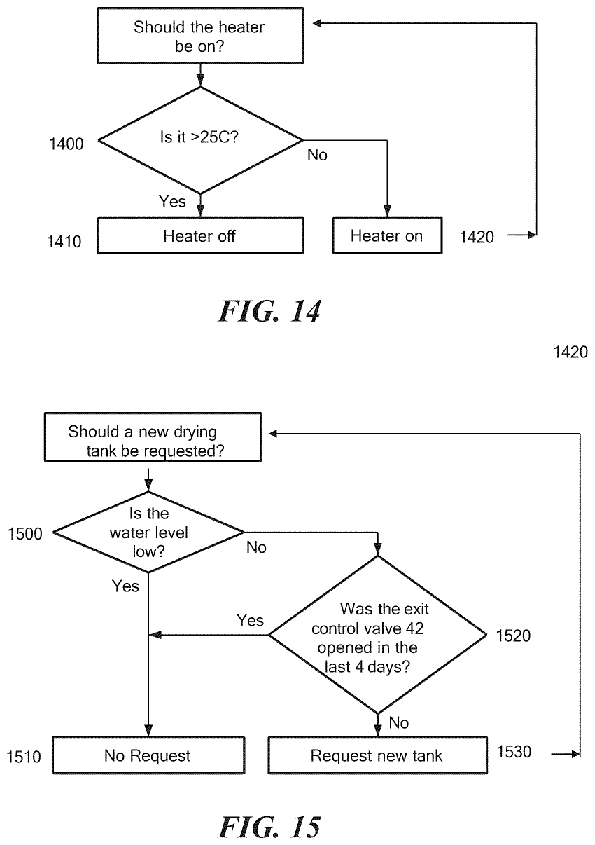

FIG. 14 is a flow diagram that shows a decision-making process in choosing if the heater 24 should in an on state. At the first step 1400, the thermal control device 56 is interrogated to determine if the temperature of the water is greater than 25 degrees C. If the temperature of the water is greater than 25 degrees C., then thermal control device 56 heater is off 1410. If the temperature of the water is less than 25 degrees C., then thermal control device 56 heater is on until the temperature exceeds 25 degrees C. 1420. After thermal control device heater is turned on, the process returns to step 1400. Preferably, the temperature is maintained within a range near 25 degrees C. or the like.

FIG. 15 is a flow diagram that shows a decision-making process in choosing if a new drying tank 46 should be requested. At the first step 1500, the drying tank water level sensor 48 is interrogated to determine if the drying tank 46 water level is low. If the drying tank 46 water level is low, then a new drying tank 46 is not requested 1510. If the drying tank 46 water level is not low, then the exit control valve 42 is interrogated 1520 to determine if the exit control valve 42 has been opened in the last four days. If the exit control valve 42 has been opened in the last four days, then a new drying tank 46 is not requested 1510. If the exit control valve 42 has not been opened in the last four days, then a new drying tank is requested 1530. After the has been requested 1530, the process returns to step 1500.

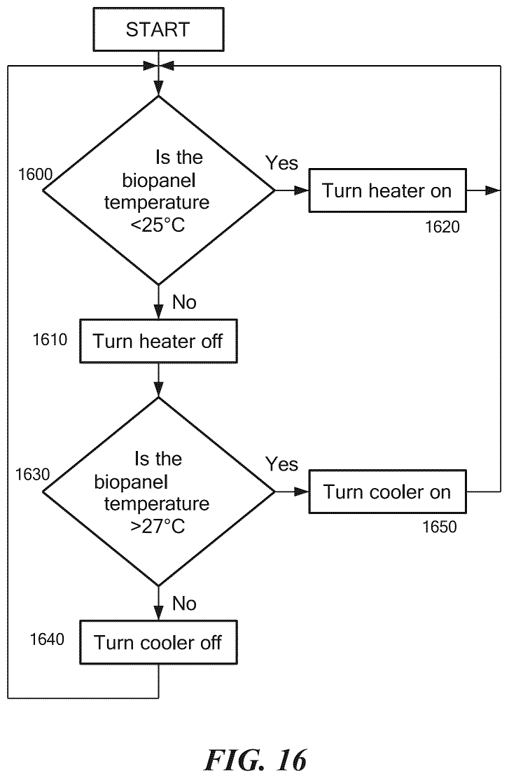

FIG. 16 is a flow diagram that shows a decision-making process in choosing if the thermal control device 56 (e.g., thermal control unit) should be in a heater state, or if the thermal control device 56 should be in a cooler state. At the first step 1600, the thermal control device 56 is interrogated to determine if the temperature of the water is less than 25 degrees C. If the temperature of the water is not less than 25 degrees C., then thermal control device heater is turned off 1610. If the temperature of the water is less than 25 degrees C., then thermal control device 56 is turned on to the heater state 1620. If the heater is turned on at 1620, then the process returns to step 1600.

As another step 1630, the thermal control device 56 is interrogated to determine if the temperature of the water is greater than 27 degrees C. If the temperature of the water is not greater than 27 degrees C., then thermal control device 56 cooler is turned off 1640, and the first step 1600 is executed again. If the temperature of the water is greater than 27 degrees C., then thermal control device 56 is placed be into the cooling state. If the cooler is turned on at 1650, then the process returns to step 1600.

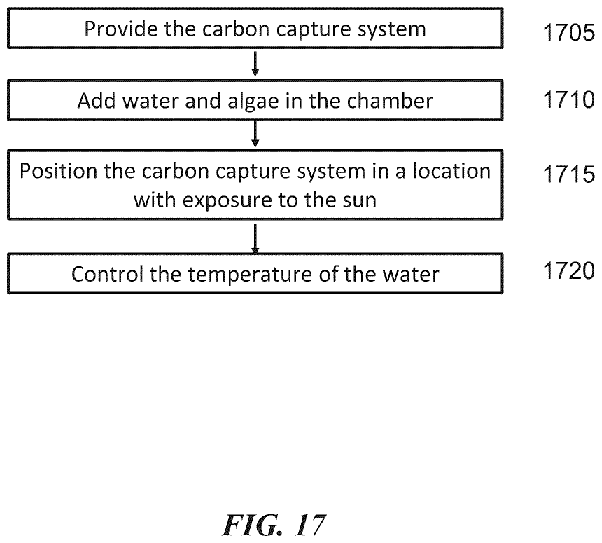

FIG. 17 describes a method of generating electrical power and generating biomass in a single system.

The process begins at step 1705, which provides the carbon capture system 12. As discussed above, the carbon capture system 12 includes a body forming a chamber 14 to receive water and algae, and the body 14 includes a solar panel cover 16. The system also includes a settling tank 26 fluidically connected to a liquid source, and the settling tank 26 is also fluidically connected to the chamber 14. The system also includes a drying tank 46 fluidically connected to the chamber 14, and at least one pump 44. The at least one fluid pump 44 is configured to move the water and the algae from the chamber 14 to the drying tank 46. The system 12 also includes a thermal control unit 56 positioned in the chamber 14, and the thermal control unit 56 is configured to control the temperature of the water;

At step 1710, water and algae are added into the chamber. Additional water can be added to maintain a predetermined water level above the algae. At step 1715, the carbon capture system is positioned in a location with exposure to the sun. The carbon capture system is positioned in the sun to allow the sunlight incident on the translucent solar panel to generate electrical power from the sunlight, and to allow some of the incident sunlight to be used by the algae to transform carbon dioxide into biomass.

Step 1720 manages/control the temperature of the water. The thermal controllers are automatically controlled by the system controller to maintain a water temperature between about 23 degrees C. to 27 degrees C.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A carbon sequestration device to remove carbon dioxide from environmental air in an exterior environment, the device comprising:
a housing forming a concave region with an open top;
a panel covering the open top, at least a portion of the panel being light-transmitting, the panel including at least one solar cell, the panel and concave region forming an interior chamber configured to contain water and algae;
an environmental air inlet formed in the housing for receiving pressurized environmental air from the exterior environment;
a temperature sensor in thermal communication with the interior chamber to sense the temperature in the interior chamber;
a thermal regulator in thermal communication with the interior chamber, the thermal regulator being configured to control the temperature in the interior chamber as a function of the temperature sensed by the temperature sensor.

2. The carbon sequestration device of claim 1 further comprising a pump inlet for receiving air from a pressurized source to create turbulence in water in the interior chamber when containing water.

3. The carbon sequestration device of claim 1 wherein the thermal regulator comprises a heater, a cooler, or a combination heater and cooler.

4. The carbon sequestration device of claim 1 wherein the housing comprises a front wall, a back wall, and two side walls extending between the front and back walls, the two side walls forming an angle to the horizontal of 2 degrees to degrees.

5. The carbon sequestration device of claim 1 further comprising a bubble stone fluidly connected with the environmental air inlet.

6. The carbon sequestration device of claim 1 further comprising an optical sensor configured to detect the turbidity of water in the interior chamber.

7. The carbon sequestration device of claim 1 wherein the panel comprises at least one electrically inactive region that is opaque or transparent to light.

8. The carbon sequestration device of claim 1 further comprising a light concentrating coating within the interior chamber.

9. The carbon sequestration device of claim 1 further comprising a settling tank inlet fluidly coupled with an external settling tank configured to manage nutrient density and nitrogen levels, the settling fluid tank inlet configured to receive fluid from the external settling tank.

10. The carbon sequestration device of claim 1 further comprising a drying tank outlet fluidly coupled with an external drying tank, the interior chamber configured to emit water and algae within the interior chamber toward the drying tank after satisfying prescribed algae concentration conditions.

11. A method of sequestering carbon, the method comprising:
receiving water in a first stage of a carbon capture system configured to determine a water quality;
directing the received water into a settling tank after determining that the water quality meets a prescribed criterion;
monitoring nitrogen and nutrient density of water in the settling tank;
evaporating water in the settling tank when nutrient density within the water in the settling tank is too low;
passing water from the settling tank to a carbon sequestration device having a housing and solar panel that form an interior chamber for receiving the water from the settling tank, the solar panel providing power to at least a portion of the carbon capture system;
determining that the interior chamber of the carbon sequestration device contains at least a prescribed amount of algae;
transferring water from the carbon sequestration device to a drying tank after determining that the carbon sequestration device contains at least a prescribed amount of algae; and
drying the algae in the drying tank to produce biomass.

12. The method of claim 11 further comprising pumping air into the interior chamber from a pressurized source to create turbulence in water in the interior chamber when containing water.

13. The method of claim 11 further comprising:
determining that the temperature in the interior chamber is outside of a prescribed temperature range; and
energizing a thermal regulator to drive the temperature of the internal chamber to be within the prescribed temperature range.

14. The method of claim 11 further comprising emitting water and algae within the interior chamber toward the drying tank after satisfying prescribed algae concentration conditions in the interior chamber.

15. The method of claim 11 further comprising monitoring nutrient levels in water in the settling tank; and evaporating water vapor when the nutrient levels are below a prescribed nutrient threshold.

16. A carbon capture system comprising:
a first stage configured to determine a water quality;
a settling tank selectively fluidly coupled with the first stage, the settling stage configured to receive and hold water from the first stage and monitor nitrogen and nutrient density of water it holds, the settling tank configured to evaporate water in the settling tank when nutrient density within the water in the settling tank is below a prescribed threshold;
a carbon sequestration device selectively fluidly coupled with the settling tank, the carbon sequestration device having a housing and solar panel that form an interior chamber for receiving the water from the settling tank, the carbon sequestration device further comprising a thermal regulator to manage the temperature of water in the interior chamber, the solar panel providing power to at least a portion of the carbon capture system;
a drying tank selectively fluidly coupled with the carbon sequestration device, the drying tank configured to receive water from the carbon sequestration device after the carbon sequestration device has grown at least a prescribed amount of algae, the drying tank configured to dry the algae in the drying tank to produce biomass.

17. The system of claim 16 further comprising the carbon sequestration device and at least a second carbon sequestration device, the second carbon sequestration device also being selectively fluidly coupled with the settling tank and the drying tank.

18. The system of claim 16 further comprising a pump inlet for receiving air from a pressurized source to create turbulence in water in the interior chamber of the carbon sequestration device when containing water.

19. The system of claim 16 wherein the thermal regulator comprises a heater, a cooler, or a combination heater and cooler.

20. The system of claim 16 further having a pump and valve system to control fluid flow between the first stage, the settling tank, the carbon sequestration device, and the drying tank.

21. The system of claim 16 further comprising a light manager configured to maintain a light intensity in the interior chamber of about 350 to 650 at peak wavelengths of 450-495 nm (Blue) and 620 to 750 nm (Red).
